(19) United States
(12) Patent Application Publication
(10) Pub. No.: US 2005/0133002 A1
(43) Pub. Date: Jun. 23, 2005

(54) Hydrogen combustion engine

(76) Inventors: Michael Hoetger, Berlin (DE); Herbert Clemens, Berlin (DE); Detlef Wusthoff, Berlin (DE)

Correspondence Address: Law Offices;Mallinckrodt & Mallinckrodt, Suite 510, 10 Exchange Place, Salt Lake City, UT, 84111, US

(21) Appl. No.: 11/015,917

(22) Filed: Dec. 17, 2004

(30) Foreign Application Priority Data
Dec. 17, 2003 (DE) 103 59 445.0-13

(51) Int. Cl. F02B 3/00

(52) U.S. Cl. 123/299

(57) ABSTRACT

The invention relates to a combustion engine (14) for combusting a mixture of a fast burning gas with air in a combustion process generating mechanical and/or electrical power. The engine (14) comprises a cylinder (10; 36) and a piston movable within the cylinder between a top dead center and a bottom dead center (18). The piston (12; 34) and the cylinder form an expansion volume. An injection nozzle (20; 44) is provided for injecting the fast burning gas into the cylinder (10; 36). The cylinder and the piston form an additional cavity (24; 38) at said top dead center in which said fast burning gas is injectable. The shape of the cavity is adapted to the shape of the flame of the combustion process and its size is large enough that no combustion reactions occur at the walls of the cavity.

### TECHNICAL FIELD

The invention relates to a power producing combustion engine for combusting a mixture of a fast burning gas and air. The engine comprises a cylinder, a piston movable between a top dead center and a bottom dead center and an injection nozzle for injecting the gas into the cylinder.

With such a combustion engine a crank shaft, for example, can be driven to move a vehicle or to run a machine. A piston is arranged within a cylinder. The piston is connected to a crank shaft. The piston moves between a top dead center and a bottom dead center. The volume between the piston and the inner volume of the cylinder (expansion volume) is a minimum at the top dead center. The expansion volume is a maximum at the bottom dead center.

The movement of the piston is caused by the expansion of the gas. A combustible fuel is injected into the cylinder before the top dead center is reached, then mixed with air and finally combusted. During this exothermal process heat and power are generated. The combusted gas is compressed very much and therefore expands. It pushes the piston in a direction out of the cylinder. This movement is transmitted to the crank shaft and can be used for the generation of mechanical power. The expanded hot exhaust gas is released in the environment at the bottom dead center. The piston then moves again in the opposite direction.

### PRIOR ART

Depending on the combustion fuel, different types of engines are distinguished. Otto motors are used, amongst others, for the vehicle technology. In such Otto motors the combustion fuel, i.e. gasoline, is swirled together with air in the combustion volume. Only then the mixture is ignited with a separate spark plug. A flame front is generated propagating from the spark plug in the direction of the cylinder walls. The cylinder walls continuously remain in contact with the burning fuel-air-mixture during the combustion until the combustion is finished. The pressure generated thereby produces the desired forces on the piston.

In an injection Diesel engine the fuel is directly injected into the compressed air within the combustion volume at the end of the compression cycle. The compressed air in the cylinder is hot and causes the self igniting of the fuel without the need of a separate spark plug. It is known to inject the fuel in one to five phases to avoid unwanted noise and vibrations. This is effected before and after reaching the top dead center. At a pre-injection a small amount of diesel is inserted per injection cycle. It is combusted with a portion of the oxygen. In the subsequent main injection, ignition is effected by the flame present due to the pre-injection. In such a way the degree of the increase of the pressure is decreased and thereby the generation of noise and vibrations is reduced. It is further known to inject small amounts of diesel fuel again in an after-injection. This is introduced to reduce the emission of particles.

Furthermore it is known to provide a recess in the piston of the diesel engine which is formed to enhance the swirling of the fuel-air-mixture. It is also known to provide a recess in the piston to avoid hitting of the valves on the piston at the top dead center. These recesses are designed such that the dead volume remains as small as possible in order not to decrease the efficiency. All injection processes are effected by means of one valve with one or more openings.

Normally modified Otto motors are used when hydrogen is combusted. Therein the hydrogen is inserted with a nozzle into the combustion volume and ignited with a spark plug. A flame front is formed propagating from the spark plug towards the cylinder wall. The combustion velocity of hydrogen is in the range of 200 m/s and is considerably higher than the combustion velocity of the other fuels, i.e. Diesel and gasoline (about 20 m/s). Apart from hydrogen engines and natural gasoline and organic gasoline engines, the use of further combustion gases are known.

In such hydrogen combustion engines the energy of the combustion process is transmitted not only to the crank shaft, but to a large extent to the exhaust gas in the form of heat and to the cooling water cooling the cylinder also in the form of heat. The efficiency of the engine is increased if more energy is transmitted in the form of mechanical power to the crank shaft when the same amount of combustion fuel is used. In other words: the efficiency is increased if the heat losses are reduced.

### DISCLOSURE OF THE INVENTION

It is an object of the invention to provide a gas combustion engine with an increased efficiency. According to the invention this object is achieved in that the cylinder and the piston form an additional cavity at the top dead center in which hydrogen or any other fast burning gas is injectable the shape of the cavity being adapted to the shape of the flame of the combustion process and having a size which is large enough that no combustion reactions occur at the wall of the cavity.

Contrary to the technical development aiming at a small dead volume to increase the efficiency, the dead volume is here increased by an additional cavity. The disadvantages involved with this step are compensated by a reduction of heat dissipation.

The invention is based on the surprising realization that the efficiency can be increased for fast burning fuels, such as, for example, hydrogen, if a cavity is provided around the injection nozzle although additional dead volume is formed thereby, not contributing to the power generation. The formation of such an additional cavity with certain geometric characteristics decreases the heat transmission between the flame of the combusted gas and the cylinder and piston wall and thereby reduces the heat loss. Thereby the efficiency is increased. The effect is enhanced if the air is—contrary to the known Otto and Diesel engines—swirled either only very little or in such a way that the heat generating combustion process occurs in the center of the expansion volume and not at the cylinder wall.

Due to the high combustion velocity the fuel is combusted already before it reaches the cylinder wall. The heat transmission to the piston and the cylinder is reduced.

The combustion gas is preferably hydrogen. Hydrogen has a high burning velocity, is environmentally friendly and can be produced in large quantities. Further combustion gases with high burning velocity, such as, for example, propane, ethanol or acetylene, however, my also be used under suitable conditions.

Preferably at least one igniting device is provided. Such an igniting device is, for example, a spark plug. The ignition is then effected by independent ignition. The ignition of the combustion gas in the cylinder of the engine may also be effected by self-ignition.

Preferably the piston is provided with a concave cavity. The injection nozzle can then be arranged in the center of the cylinder so that the distance between the injection nozzle and the cavity wall is about the same in all directions.

The cylinder head may also be provided with a concave cavity forming the additional cavity together with the concave cavity of the piston. The additional cavity may be essentially spherical and the end of the injection nozzle may be arranged in the center of the cavity. In this case the injection nozzle is fully separated from the wall of the expansion volume with a distance already at the top dead center.

Instead of one igniting device several igniting devices may be provided. It can be reasonable to provide more than one additional cavities.

In a particularly preferred embodiment of the invention the injection nozzle is provided with a plurality of openings. The contact surfaces of the combustion gas jets injected by each injection nozzle to the combustion air thereby is larger and the fuel-air-mixture can be combusted particularly fast. Preferably these openings are directed such that they have the largest possible distance from the cylinder and piston wall, respectively.

The injection nozzle may be made from high temperature resistant material at its end, especially from ceramics. In this case this provides the option that the nozzle protrudes a little into the cavity.

In a particularly preferred embodiment of the invention the injection nozzle is provided with means for fast controlling of the injection process. The injection process may then be controlled in the time frame around the top dead center or up to the top dead center in such a way that the combustion process is concentrated in the central range of the cavity or the expansion volume.

The injection of the combustion gas can be effected in a series of several injection processes. The injection process is interrupted in very fast cycles until the respective gas portion is practically completely combusted. Thereafter the next partial injection is activated. In such a way the fuel is individually combusted for each individual injection. Thereby, the formation of a flame front propagating to the wall of the expansion volume is impeded. Contrary to a pre-injection of a diesel engine the fuel is almost completely combusted and swirling is not desired. The main injection of a diesel engine, however, is effected into the combustion of the pre-injection. The pulsed injection enhances the effect of a combustion without wall contact.

The injection can be effected with a large number of injection processes, for example up to 50 processes per operating cycle. Preferably the injection processes are carried out exclusively during the time before the top dead center is reached or around the top dead center and its duration maximally lasts for a tenth of an operating cycle.

Further modifications of the invention are subject matter of the sub-claims. A preferred embodiment is described below in greater detail with reference to the accompanying drawings. While the invention is described for a specific embodiment advantages and modifications are possible without deviating from the idea of the invention and they are not meant to limit the scope of the invention, which is set forth in the accompanying claims.

### BRIEF DESCRIPTION OF THE DRAWINGS

FIG. 1 is a cross section through a hydrogen combustion engine schematically shown with a hemispherical cavity at the top dead center.

FIG. 2 is a cross section through a hydrogen combustion engine schematically shown with hemispherical cavity at the top dead center.

FIG. 3 shows the injected volumes for the respective crank angles

FIG. 4 is a cross section through a hydrogen combustion engine schematically shown with two additional circular cavities at the top dead center injection which has a positive effect on the flows.

### DETAILED DESCRIPTION OF PREFERRED EMBODIMENTS

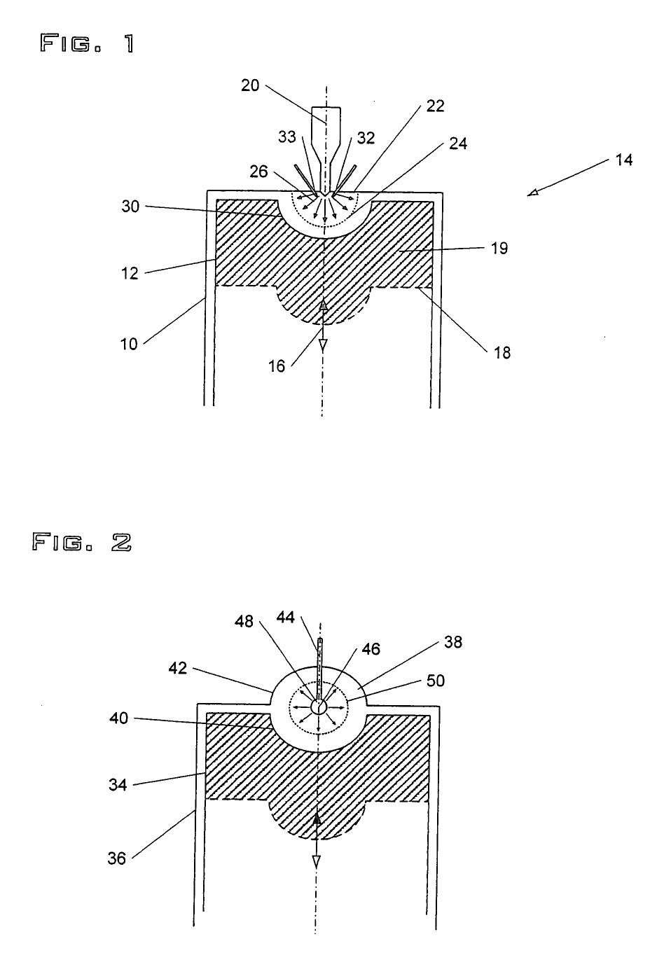

FIG. 1 shows a cross section through a schematically represented cylinder 10 and a piston 12 of a hydrogen combustion engine generally denoted with numeral 14. The piston 12 is arranged in the cylinder and moves in the direction of an arrow denoted with numeral 16. In FIG. 1 the piston 12 is at the top dead center. This means that the expansion volume is at a minimum. From this position the piston 12 moves downwards in FIG. 1 to the bottom dead center. This is shown by a dashed line 18. The expansion volume, shown as a hatched area, is then at a maximum. The expansion volume, therefore, is variable with the movement of the piston.

A nozzle is arranged at the top end of the cylinder 10. The nozzle 20 ends at the wall 22 of the cylinder 10. Hydrogen emerges from the nozzle in all directions, and is controlled by a valve control (not shown). This is represented by arrows 26. The hydrogen enters the cavity 24 which is formed by a recess in the piston 12. Contrary to the expansion volume, the additional cavity 24 has a constant volume. The cavity 24 is formed by the upper cylinder wall 22 and the wall of the recess 30. Spark plugs 32 and 33 are provided at the nozzle 20. The combustion process is started with such spark plugs 32 and 33. The hydrogen and the oxygen comprised in the air in the cavity react in an exothermal chemical reaction. This causes a pressure wave pushing the piston 12 downwards in FIG. 1. The reaction takes place very quickly and is essentially finished before it reaches the wall of the cylinder or the piston, respectively. The essential portion of the reaction occurs in the area of the central starting point for combustion at the spark plugs or the nozzle.

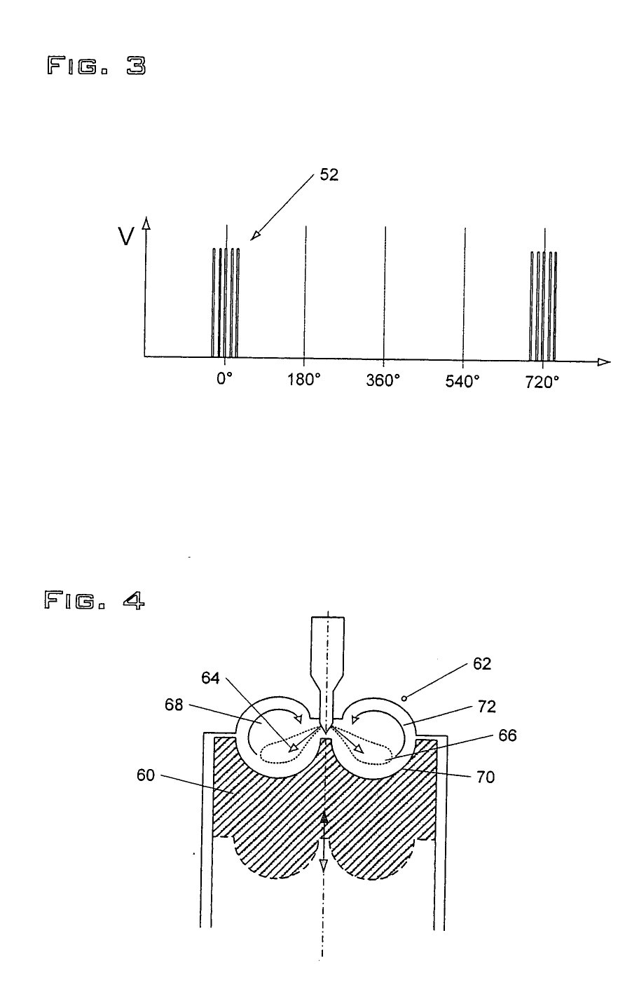

FIG. 2 shows an alternative embodiment of the invention. There is also a piston 34 provided in a cylinder 36. In this embodiment, however, the cavity 38 is spherical. The lower half of the sphere is formed by a concave recess 40 in the piston. The upper half is formed by a concave recess 42 in the cylinder head 36. The recesses 40 and 42 are arranged to join each other. A high temperature resistant injection nozzle 44, made of ceramics extends to the center of the sphere 46. The end 48 of the injection nozzle is also spherically shaped and provided with a plurality of openings. Hydrogen is injected in all directions into the spherical cavity through such openings. The openings are distributed in such a way that a maximum distance to all walls of the cavity is achieved. Correspondingly the combustions essentially takes place in the center in a range around the nozzle as represented by a dotted line 50. The combustion is essentially finished here also before heat is transmitted to the walls. The ignition of the combustion gas in the cavity 38 is effected in this embodiment by self-ignition. However, spark plugs may also be used. For optimizing the combustion process a very fast controllable injector is used. Such an injector is described in DE 102 34 50 31 A1 which is incorporated herein by reference. With such an injector it is possible to very accurately control the injection process. The injection process is started shortly before the top dead center is reached. This is shown in FIG. 3. The injection volume is represented depending on the crank angle. In FIG. 3 two cycles are shown. The injection process is interrupted several times to provide pulse-like injections of the fuel. In FIG. 3 five injection processes 52 are shown per cycle. However, depending on the layout of the cylinder, the piston and the cavity, more or less injection processes per cycle may be more suitable. The pulse frequency is very high. In such a way almost a complete combustion of the hydrogen may be achieved near the openings of the nozzle 24 or 50, respectively. By the pulsed injection effected under very high pressure the flame burns in a pulsed manner. The size of the flame varies during the injections depending on the frequency and the duration of the injection pulses. These variations avoid the propagation of the flame front to the cylinder and piston wall. In total the same amount of exhaust gas is produced as with a continuous injection.

A further advantage of the pulsed injection is the avoiding of high temperatures. Furthermore the flame front can not be formed at the cylinder wall. Thereby the heat loss is considerably reduced. With low exhaust temperatures the efficiency is improved and the formation of damaging nitrogen oxides NOₓ is avoided.

In FIG. 4 yet another embodiment is shown wherein the piston 60 and the cylinder head 62 form cavities 68 with circular cross sections. Such cavities can form two spheres, two lying cylinders or a torus. The tangential injection or the injection from the side 64 is carried out in a pulsed manner as described above. Thereby a varying combustion flame 66 is produced not filling the entire cavity 68 and not having direct contact with the piston walls 70. Due to the circular cross section of the cavity 68 the flame generates a turbulence 72 in the cavity which in turn feeds the flame with combustion air. This supports the stable generation of a pulsed flame near the nozzle.

Whereas the invention is here illustrated and described with reference to embodiments thereof presently contemplated as the best mode of carrying out the invention in actual practice, it is to be understood that various changes may be made in adapting the invention to different embodiments without departing from the broader inventive concepts disclosed herein and comprehended by the claims that follow.

1. An internal combustion engine (14) for the combustion, in a combustion reaction, of a gas having high combustion velocity, comprising: a cylinder (10; 36), having an end wall, a piston (12; 34) movable in said cylinder between a first dead center in which said piston is near said cylinder end wall and a second dead center (18), in which said piston is remote from said end wall, said end wall and said cylinder defining an expansion chamber therebetween, said expansion chamber having a size variable with the movement of the piston and injection means having an outlet end for injecting said gas into said cylinder, wherein
said cylinder and said piston define, when said piston is near its first dead center an additional cavity (24; 38) with constant volume having a cavity wall and communicating with said expansion chamber,
said injection means being arranged to inject said gas into said additional cavity,
said additional cavity being dimensioned and shaped to cause said combustion reaction substantially at a distance from said cavity wall.

2. An internal combustion engine as claimed in claim 1, wherein said gas having high combustion velocity is hydrogen.

3. An internal combustion engine as claimed in claim 1, wherein at least one igniting device is provided.

4. An internal combustion engine as claimed in claim 1, wherein said piston is provided with a concave cavity.

5. An internal combustion engine as claimed in claim 4 wherein said cylinder end wall is provided with a concave cavity forming said additional cavity (38) together with said concave cavity of said piston.

6. An internal combustion engine as claimed in claim 5, wherein said additional cavity is essentially spherical with a center, and wherein said outlet of said injection means is arranged in said center of said cavity.

7. An internal combustion engine as claimed in claim 1, wherein said cylinder has a longitudinal axis and said injection means is arranged in such a way that said gas is injected either tangentially or from a side of said cavity, said side being opposite to said longitudinal axis of said cylinder into said cavity.

8. An internal combustion engine as claimed in claim 1, wherein said injection means (44) is provided with a plurality of openings.

9. An internal combustion engine as claimed in claim 8, wherein said openings are directed such that they have the largest possible distance from said cylinder and piston wall, respectively.

10. An internal combustion engine as claimed in claim 1, wherein said outlet of said injection means (44) is made from high temperature resistant material, especially from ceramics.

11. An internal combustion engine as claimed in claim 1, wherein said injection means is provided with means for fast controlling of the injection process.

12. A method for operating an internal combustion engine for the combustion, in a combustion reaction, of a gas having a high combustion velocity, and wherein the internal combustion engine comprises a cylinder (10; 36) having an end wall, a piston movable in said cylinder between a first dead center, in which said piston is near said cylinder end wall and a second dead center (18), in which said piston is remote from said end wall, said end wall and said cylinder defining an expansion chamber therebetween, injection means having an outlet end for injecting said gas into said cylinder, said method comprising injecting said gas into the cylinder in a series of several injection processes (52).

13. A method as claimed in claim 12, wherein at least 10 to 50 injection processes (52) are activated per operating cycle.

14. A method as claimed in claim 12, wherein said injection processes are carried out exclusively during the time before the top dead center is reached or around the top dead center and its duration maximally lasts for a tenth of an operating cycle.
